(19) United States
(12) Patent Application Publication
(10) Pub. No.: US 2015/0199174 A1
(43) Pub. Date: Jul. 16, 2015

(54) Method for Checking an Output

(71) Applicant: Robert Bosch GmbH, Stuttgart (DE)

(72) Inventor: Eberhard Boehl, Reutlingen (DE)

(21) Appl. No.: 14/590,537

(22) Filed: Jan. 6, 2015

(30) Foreign Application Priority Data
Jan. 10, 2014 (DE) 10 2014 200 309.1

(51) Int. Cl. G06F 7/58

(52) U.S. Cl. CPC G06F 7/58

(57) ABSTRACT

A method for checking an output signal from a random source of a random number generator includes receiving the output signal from a random source. The output signal includes first random bits that have a bit length of at least one bit. The random source is sampled using a sampling unit to produce the output signal. The method further includes processing, using a processing unit, the output signal from each sampling unit. The method further includes counting the ones and zeros from the output signal to form a first difference in the ones and zeros for a first fixed number of the first random bits. The method further includes comparing the first difference with a predetermined value. The method further includes checking the first random bits based on the comparison.

This application claims priority under 35 U.S.C. §119 to patent application no. DE 10 2014 200 309.1 filed on Jan. 10, 2014 in Germany, the disclosure of which is incorporated herein by reference in its entirety.

The disclosure relates to a method for checking an output from a random source of a random number generator and to an arrangement for carrying out the method.

### BACKGROUND

Random numbers as results or outputs from random sources in random number generators are needed for many applications. Random number generators are processes that deliver a series of random numbers. A definitive criterion for the quality of random numbers is whether the result of the generation can be regarded as being independent of earlier results.

Random numbers are needed for cryptographic processes, for example, and are used to generate keys for these encryption processes. Thus, random number generators (RNG) are used in order to produce master keys for symmetric encryption processes and protocol handshaking in ECC (elliptical curve cryptography), which prevent power analysis attack and replay attacks.

There are two basic types of random number generators, namely firstly pseudo random number generators (PRNG) for high throughputs and low security levels. Usually, a secret value is input into a PRNG and each input value will always result in the same output series. However, a good PRNG will output a numerical series that is of random appearance and will pass most tests.

It should be noted that keys for cryptographic processes are subject to high requirements in respect of the random number properties. Therefore, pseudo random number generators (PRNG), for example represented by an LFRS (linear feedback shift register), are unsuitable for this purpose. Only a generator of true random numbers, called a true random number generator (TRNG), meets the stated requirements. This is the other type of random number generator. This makes use of natural noise processes in order to obtain an unpredictable result.

Noise generators that make use of the thermal noise from resistors or semiconductors or the shot noise at potential barriers, for example at pn junctions, are customary. A further option is to make use of the radioactive decay of isotopes.

While the “classic” processes use analog elements, such as resistors, as noise sources, there has been in the more recent past the frequent use of digital elements, such as inverters. These have the advantage of lower complexity for the circuit layout, because they are present as standard elements. In addition, such circuits can also be used in user programmable circuits, such as FPGAs.

By way of example, the use of ring oscillators is thus known, which are an electronic oscillator circuit. In these, an uneven number of inverters are interconnected to form a ring, which results in oscillation at a natural frequency. In this case, the natural frequency is dependent on the number of inverters in the ring, the properties of the inverters, the conditions of the interconnection, namely the line capacitances, the operating voltage and the temperature. The noise from the inverters produces a random phase shift in comparison with the ideal oscillator frequency, which is used as a random process for the TRNG. It should be noted that ring oscillators oscillate independently and do not require external components, such as capacitors or coils.

The output from the ring oscillators can be compressed or subjected to post-processing in order to consolidate or focus, i.e. increase, the entropy and to eliminate any tendency (bias).

One problem in this connection is that the ring oscillator needs to be sampled as close as possible to an expected ideal edge so that a random sample is obtained. In this regard, the publication by Bock, H., Bucci, M., Luzzi, R.: An Offset-compensated Oscillator-based Random Bit Source for Security Applications, CHES 2005 shows a way in which the sampling always takes place close to an oscillator edge as a result of the regulated shifting of the sampling instant.

The printed document EP 1 686 458 B1 discloses a method for producing random numbers using a ring oscillator in which a first and a second signal are provided, wherein the first signal is sampled when triggered by the second signal. The method described involves a ring oscillator being sampled repeatedly, with only ever noninverting delays, namely an even number of inverters as delay elements, being utilized. In this case, the oscillator ring is sampled, beginning from a starting point, always after an even number of inverters simultaneously or with a reciprocal delay. This makes it possible to dispense with the shift in the sampling instant; instead, the multiple sampling signals are evaluated.

The publication “Design of Testable Random Bit Generators” by Bucci, M. and Luzzi, R., CHES 2005 presents a method that can be used to establish influencing of the random source. This makes it possible to prevent attacks. A direct distinction between random values and deterministic values is not possible by this means, however. It is possible for the quality of the random source to be rated by counting the transitions.

A further option is provided by the use of multiple ring oscillators. This is outlined in the publication Sunar, B. et al., Approvable Secure True Random Number Generator with Built In Tolerance Attacks, IEEE Trans. On Computers, 1/2007, for example. This involves the logic combination and evaluation of samples from a plurality of ring oscillators.

As has already been explained, ring oscillators involve an uneven number of inverters being interconnected to form a ring, which results in oscillation at a natural frequency. In this case, the natural frequency is dependent on the number of inverters in the ring, the properties of the inverters, the conditions of the interconnection, i.e. the line capacitances, the operating voltage and the temperature. The noise from the inverters produces a random phase shift in comparison with the ideal oscillator frequency, which is utilized as a random process for the TRNG.

An advantageous implementation of a TRNG source using a ring oscillator that is sampled at multiple points is shown in FIG. 1. This circuit simultaneously affords the advantage that a correlation with the system clock can be established and errors can be detected when there are particular implementation conditions with even capacitive loading on all the nodes of the ring oscillator and the switching elements used, such as flipflops, inverters, are designed such that they react to rising and falling edges as evenly as possible.

Printed document DE 60 2004 011 081 T2 describes a way of testing a TRNG source following “post processing” and how this is accomplished by putting this post processing into a certification mode.

### SUMMARY

Against this background, a method having the features of the disclosed subject matter and an arrangement according to the disclosed subject matter are represented. Embodiments can be found in the claims and in the description.

A method is presented that, in one refinement, is based on a compression method for post processing an output from a random source of a random number generator. In the case of this underlying compression method, the random source outputs a digital output signal having a bit length of at least one bit, the output signal being compressed. In this case, the compression involves block-by-block linear logic combination being performed for n successive bits of the output signal, where n is a compression factor, which produces a compressed output signal that comprises a series of compressed signal values. The series of compressed signal values can be checked in respect of the distribution thereof.

In the case of this compression method, one refinement may have provision either for the bits of the output signal to be logically combined directly by means of a linear operation and for this combined signal to be serially compressed by means of a linear operation, or for initially bit-by-bit compression to take place and for the compressed values then to be subjected to further processing, for example linear logic combination. In this case, a first post processing step and a second post processing step may be provided, with linear logic combination, for example using an XOR element or an XNOR element, being performed in at least one of the two.

All the methods hitherto with exclusively digital elements as an entropy source, for example an uneven number of inverters connected to form a ring, require to some extent very complex post processing circuits that firstly enrich the entropy and secondly ensure an even distribution for the random bits between the values zero and one. The compression method presented provides a simple option for post processing. In particular, it is possible to dispense with the complex post processing with a certification mode that is described in the printed document DE 60 2004 011 081 T2.

According to the compression method presented, a TRNG source having a plurality of outputs can be used, each of these outputs being equipped with a simple compression function, for example a serial XOR. The complexity of such a method is so low that a TRNG can be implemented with approximately 200 gate equivalents. This is distinctly more favorable than in the case of known methods.

By way of example, block-by-block linear logic combination can be achieved by means of a serial XOR, with the output signal being linearly XORed with an intermediate signal, for example. XNORing is likewise possible. In this case, the result of this logic combination is stored in a memory element, for example a flipflop. The output signal from this memory element is the intermediate signal. The compressed signal formed in the memory element in this way is read after a prescribed number n of clock cycles. The memory element is then reset. The number n should be as uneven as possible, because then n zeros and n ones deliver different results.

The check on the distribution can be carried out, by way of example, by counting the occurrence of bit value zero and bit value one in separate counters for m compressed output bits and performing the comparison by forming the difference in these counter values and by comparing the difference with a prescribed limit.

If the random source used is a ring oscillator, the frequency thereof can be influenced by the choice of the number of inverting elements or else by changing the operating conditions, such as operating voltage, temperature, etc. The number of inverting elements in the ring oscillator can be changed as follows:

a) Generic approach to the synthesis with a variable number of inverting elements. This can only be carried out in an FPGA after fresh synthesis, however.
b) Structure of the ring oscillator provided with inverting elements that to some extent can be bypassed, under the control of a control signal. This supplementary circuit amplifies the unequal capacitances of the nodes in the ring oscillator. This does not have a disadvantageous effect, however, if the compression factor and/or the sampling frequency is and/or are varied accordingly.

Changes to the operating conditions can be made as follows:

a) by means of a separately controllable supply voltage that is routed out explicitly or by means of series resistors in the supply for the ring oscillator (voltage drop),
b) by means of heating or cooling elements that are selectively engaged.

By way of example, reciprocal comparison of the number of zeros and ones means that the largest and smallest number of an allocation are established by means of a greater-than/less-than comparison, e.g.

a) by checking whether a difference becomes negative or
b) by comparing the counter values on a bit-by-bit basis starting from the MSB; at the first discrepancy at a bit position, the value with a 1 at this position is larger than the other and then the difference is formed from the largest and smallest values and is in turn compared with a fixed limit.

Hence, a compression method is used in which the even distribution between zero and one is achieved by simple compression by means of XORing. The uneven distribution referred to as “bias” is achieved by an appropriate degree of compression in conjunction with a suitable choice of sampling frequency.

A suitable checking method can be used to establish whether the bias is low enough or, by way of example, a sufficiently high random value cannot be achieved on account of a correlation between the oscillator and an internal or external clock.

The method presented provides a way of checking the quality of the internal random numbers following simple compression.

In this case, it is possible to use a TRNG source having a plurality of outputs, wherein all the outputs are logically combined with one another in linear fashion, for example XOR, XNOR, and this combined output signal is equipped with a simple linear compression function, for example serial XOR or XNOR. The complexity of such a method is so low that a TRNG can be implemented with approximately 200 gate equivalents. This is distinctly more beneficial than in the case of known methods.

For the output signal that is compressed in one refinement, the zeros and ones it contains are counted and a difference is formed for these two counts. In this case, it is particularly advantageous if a simple up/down counter is used that increments for every “1” and decrements for every “0”. As a result, the difference is formed directly in the counter. After a firmly prescribed number of output bits, this difference is compared with a prescribed fixed comparison value.

Further advantages and refinements of the disclosure can be found in the description and in the accompanying drawings.

It goes without saying that the features cited above and those yet to be explained below can be used not only in the respectively indicated combination but also in other combinations or on their own without departing from the scope of the present disclosure.

### BRIEF DESCRIPTION OF THE DRAWINGS

The disclosure is schematically illustrated using an exemplary embodiment in the drawing and is described in detail below with reference to the drawing.

FIG. 1 shows an embodiment of a ring oscillator.

FIG. 2 shows the ring oscillator with subsequent XORing and compression.

FIG. 3 shows the counting of zeros and ones in separate counters.

FIG. 4 shows difference formation for counter readings.

FIG. 5 shows difference formation for counter readings using an up/down counter.

### DETAILED DESCRIPTION

The disclosure is shown schematically in the drawings on the basis of embodiments and is described in detail below with reference to the drawings.

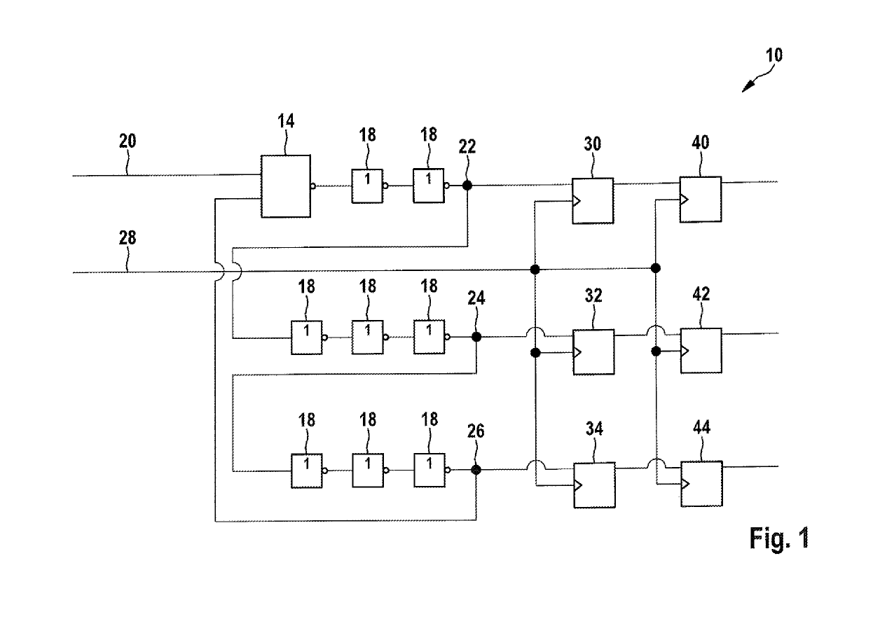

FIG. 1 shows an embodiment of a ring oscillator as a random source that is denoted as a whole by reference numeral 10. The ring oscillator 10 has a NAND element 14 and eight inverters 18 and hence nine inverting elements. Therefore, the ring oscillator 10 has an uneven number of inverting elements and three taps or sampling points.

The ring oscillator 10 can be started and stopped with a first input 20. The sampling rate is prescribed by means of a second input 28. In addition, the illustration shows a first sampling point 22, a second sampling point 24 and a third sampling point 26. This means that, beginning at the first sampling point 22, sampling always takes place after an uneven number of inverting elements. This is not absolutely necessary for the presented method, however.

The first sampling point 22 is sampled using first flipflop 30, and the sample s10 is obtained. The second sampling point 24 is sampled using a second flipflop 32, and the sample s11 is obtained. The third sampling point 26 is sampled using a third flipflop 34, and the sample s12 is obtained. The first flipflop 30 has an associated further fourth flipflop 40. This performs a storage function and outputs the value s10′, which follows the value s10 in time, i.e. s10 and s10′ are temporally successive samples from the first sampling point 22. Accordingly, the second flipflop 32 has an associated fifth flipflop 42, which outputs s11′, and the third flipflop 34 has an associated sixth flipflop 44, which outputs s12′. The flipflops 40, 42 and 44 are suitable for resolving metastable states of the flipflops 30, 32 and 34. Metastable states arise as a result of changeover of the signal at the input 28 taking place during an edge at the sampling point 22, 24 or 26.

The flipflops 30, 32 and 34 then require a particular time before a stable final stage is reached. This time is ensured in the present example by virtue of the now stable value of the flipflops 30, 32 and 34 being transferred to the flipflops 40, 42 and 44 only upon the next active edge of the signal at the input 28. Flipflops 30, 32, 34, 40, 42 and 44 serve as memory elements.

In principle, the ring oscillator 10 may therefore be made up of nine inverters 18, for example. In this case, one of these inverters 18 can be replaced by the NAND element 14 in order to be able to stop the ring oscillator 10. Alternatively, this NAND element 14 can also be replaced by a NOR element.

In the embodiment shown, the values of the ring oscillator 10 are stored on three different inverters simultaneously in one flipflop (FF) 30, 32, 34 each. These taps are meant to be distributed as evenly as possible over the elements of the ring oscillator 10. Therefore, a tap or a sampling point 22, 24, 26 is provided after three respective interverting elements in the case of nine inverting stages in the ring oscillator 10. As already mentioned, this is not necessary for the method presented, however. It is also possible for a tap to be provided again after an even number of inverting elements.

The number of inverter stages in the ring oscillator 10 determines the frequency of the oscillator and should therefore be chosen such that the flipflops can store the respective signal value. If the highest possible oscillator frequency is used, there is a higher probability of being close to an edge during the sampling. Therefore, the smallest possible number of inverters is chosen in the oscillator ring, but enough for the flipflops to be capable of operation for the frequency attained. For 180-nm technology, a frequency of approximately 1 GHz has been determined for the ring oscillator 102 with nine inverters 18 by means of simulation. The flipflops can store the signal values at this frequency, as has been demonstrated.

The method presented can be carried out with the ring oscillator 10 shown in FIG. 1, which has an uneven number of inverting elements, with values being tapped off from at least one sampling point of the ring oscillator 10.

For the ring oscillator 10, it is possible to establish a correlation with the system clock and hence with the sampling clock obtained therefrom. To this end, a comparison is performed to determine whether the three bit values at the output of the flipflops 30, 32 and 34 are identical to those at the output of the flipflops 40, 42 and 44. Not all correlations can be established by the comparison of s10, s11, s12 with s10′, s11′, s12′ in this case, even if the division value of the frequency divider can be divided by the number of inverting elements in the oscillator ring. In this case, it may occur that after a respective arbitrary, possibly constant, number of sampling operations there is recurrent sampling at the same position in the oscillator cycle. If this number is not simultaneously a divisor of the number of inverting elements in the oscillator, no advice of the present correlation is obtained from the comparison described above. It is then nevertheless possible to establish the correlation if all the sampling operations are compared with the current sampling operation. This is very complex, however.

For the ring oscillator shown in FIG. 1 with, by way of example, 9 inverters and 3 sampling points, the bit values stored at the sampling points usually change at least one bit value after a not excessive number of sampling operations. A high number of successive equal bit values is recognized from the counting of warnings, and either an error is signaled or the frequency of the oscillator is influenced.

For the ring oscillator shown in FIG. 1, nine inverts and three sampling points are therefore provided. A first flipflop, which is respectively connected to a sampling point of the oscillator, is used to store the states of the oscillator at the sampling point. The second series of downstream flipflops is suitable for compensating for metastable states in the respective first flipflops. Such metastable states can arise as a result of the sampling clock becoming active precisely during a state transition of the oscillator. The fresh storage of the state in the respective second flipflop ensures that the state of the first flipflop can settle over a period of the sampling clock before this stable value is transferred to the second flipflop. If this structure is implemented in balanced fashion, it is possible to achieve a desired response. However, balancing requires the use of special gates, namely inverters and flipflops, that have sufficiently equal driver strength for the low-high and high-low edges for the internal nodes of the flipflops too. Furthermore, the layout needs to be designed such that equal load capacitances are present for all the taps of the ring oscillator and the actuating nodes thereof. In the case of a balanced circuit as shown in FIG. 1, the bit allocations 000 and 111 do not arise, for example.

In an available test chip, gates from a digital standard library have been used. Additionally, the ring oscillator may also have a tap to which an amplifier is connected for the purpose of frequency measurement. During measurements on this test chip, it has been possible to establish that the forecast distribution of the output bits is incorrect. Both the value 000 and the value 111 arise. In addition, it has been found that the distribution of the remainder of the six states does not occur in evenly distributed fashion, even if the sampling frequencies are varied. In particular, it has been found that in the test chip under consideration the number of sampling operations with the decimal values of the three sampling bits 3, 5 and 6 is distinctly higher than that from 1, 2 and 4.

It has been recognized that, if post processing is performed in which the three output bits are XORed with one another, 0 occurs as the result much more frequently than 1. Such an imbalance in the 0-1 distribution (bias) should actually be avoided or at least corrected by means of suitable post processing. The resultant series of random bits is also called an internal random series that should have an even distribution of 0 and 1, see: Killmann, W., Schindler, W.: AIS 31, Version 1, BSI dated 25 Sep. 2001. If such a distribution of the internal random series is not possible, a complex structure is also permitted as post processing that generates random numbers from the internal random series. Since such structures possibly produce distortion that merely conceals the true, namely inadequate, response, a particular level of testability even after the post processing is required if the test on the internal random series was not successful. This certification mode required for this purpose is described in the printed document DE 60 2004 011 081 T2, for example. If such a test is passed, the post processing structure is then regarded as suitable and the tests for the even distribution of 0 and 1 can also be shown on the output data from this complex post processing structure.

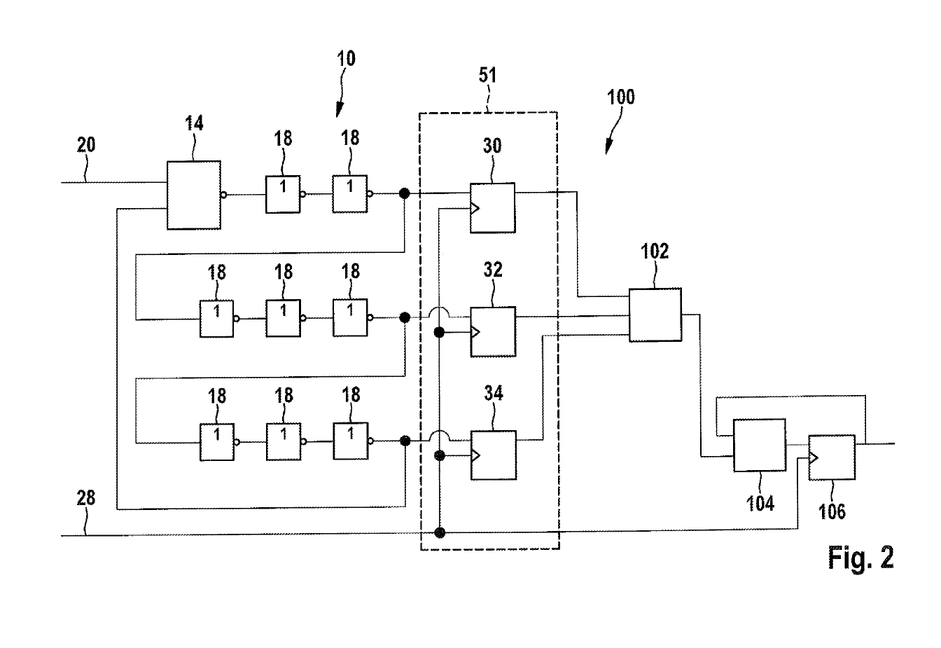

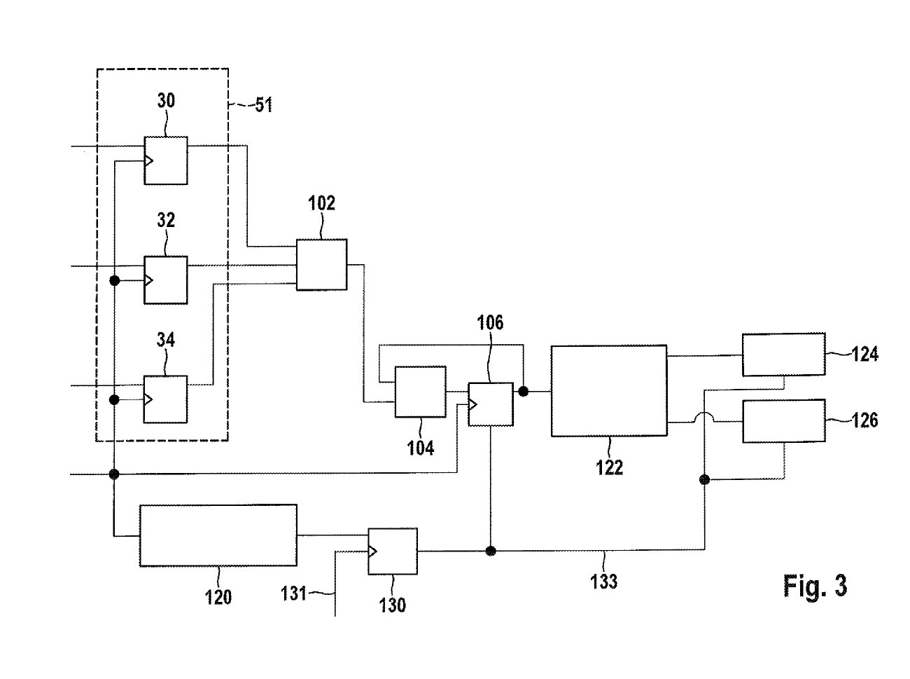

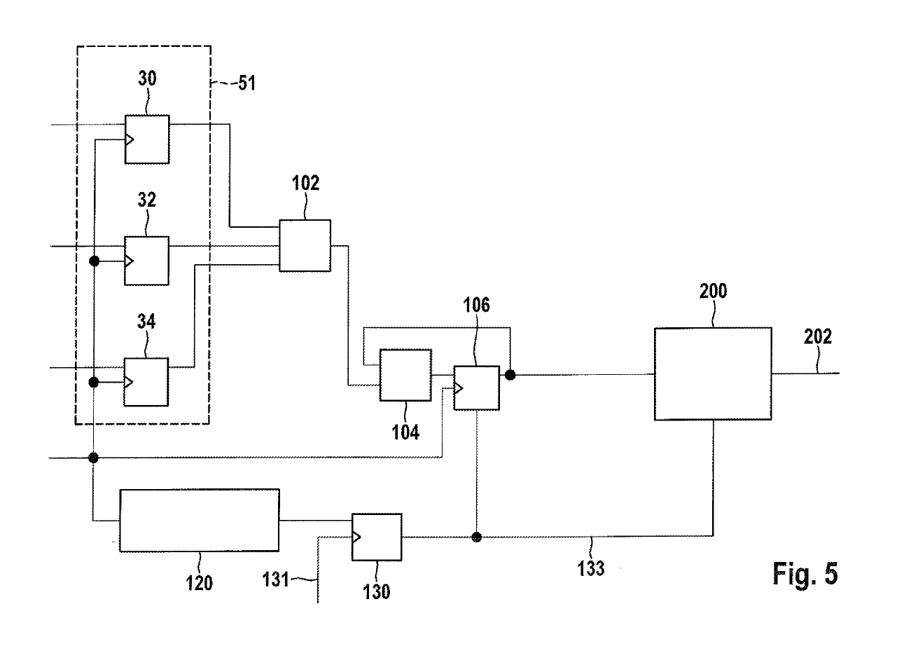

The effect achieved with the method described is that of economizing on such a structure and particularly on the certification mode. This is possible when the compression is performed such that the internal states of the post processing circuit are reset after every output of a random bit. To this end, simple compression is already performed on a bit-by-bit basis, for example, before the individual bits are processed further. In the circuit in FIG. 2, compression using a respective serial XOR is proposed before the value is stored in the second flipflop. The memory element 106 in FIG. 2, FIG. 3 and FIG. 5 is reset after every output. The resultant “stateless” compression economizes on an additional certification mode.

For the ring oscillator, 9 inverters and 3 sampling points are provided as shown in FIG. 1. A first flipflop, which is respectively connected to a sampling point of the ring oscillator, is used to store the states of the oscillator at the sampling point. The second series of downstream flipflops is suited to compensating for metastable states in the respective first flipflops. Such metastable states can arise as a result of the sampling clock becoming active precisely during a state transition in the oscillator.

The fresh storage of the state in the respective second flipflop ensures that the state of the first flipflop can settle over a period of the sampling clock before this stable value is transferred to the second flipflop.

In an available test chip, gates from a digital standard library have been used for the oscillator circuit described above. Since these gates have unequal driver strengths for low-high and high-low edges and the oscillator is furthermore provided with an additional output for frequency measurement, the possible allocations of the output signals are not evenly distributed, but rather have a high level of distortion (bias).

If post processing is now performed in which the three output bits are XORed with one another, 0 occurs much more frequently as the result than 1. Such an imbalance in the 0-1 distribution (bias) should actually be avoided (requirement of the BSI for TRNGs) or at least corrected by means of suitable post processing. The resultant internal random series should have an even distribution of 0 and 1 (see: Killmann, W., Schindler, W.: AIS 31, Version 1, BSI dated 25 Sep. 2001). If such a distribution of the internal random series is not possible, a complex structure is also permitted as post processing that generates random numbers from the internal random series. Since such structures possibly produce distortion that merely conceals the true (inadequate) response, the BSI requires a particular level of testability after the post processing too if the test on the internal random series was not successful. This certification mode that is required therefor is described in the printed document DE 60 2004 011 081 T2, for example. If such a test is passed, the post processing structure (the post processing) is therefore regarded as suitable and the tests for the even distribution of 0 and 1 can also be shown on the output data from this complex post processing structure.

The evidence will now be provided that simple compression according to the method described above produces internal random numbers that meet the requirements of even distribution.

According to the proposed method, simple compression can be performed on a bit-by-bit basis already before the individual bits are processed further. This variant has the disadvantage that every sampled signal needs to be compressed individually and then the distribution of all eight possible allocations needs to be checked with regard to their distribution. As evaluations on the test chip and on an FPGA implementation have shown, the examination of the even distribution of a signal combined from these three output signals also permits the conclusion as to whether the required randomness of the signal is reached. It is also proposed that the counter values of the possible allocations, for example eight in the case of three signals or two in the case of one combined signal, are checked to determine whether a prescribed maximum value is exceeded by at least one of these counters.

FIG. 2 shows an arrangement 100 with the ring oscillator 10 from FIG. 1, which is sampled with a sampling unit 51 that comprises the three first flipflops 30, 32, 34. Outputs s10, s11 and s12 of the sampling unit 51 are processed in a first XOR element 102 and a second XOR element 104. The output of the second XOR element 104 is passed to a second flipflop 106.

In the arrangement 100 in FIG. 2, compression with a serial XOR is proposed after the plurality of outputs of the random source have been logically combined with one another in linear fashion (XOR, XNOR). This compressed value is stored in the second flipflop 106. In this case, the second flipflop 106 simultaneously performs the task of taking account of metastable states in the first flipflop 30, 32 or 34 by virtue of an entire sampling period being available for this unstable state to settle. Instead of the compression, there may also be provision for other processing. For this, a processing unit is provided.

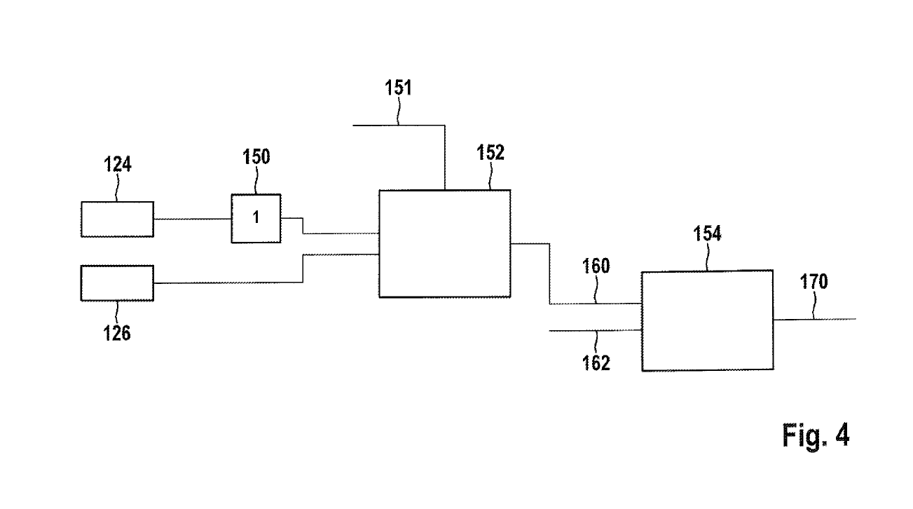

As continuing examinations on the test chip and FPGA have shown, examination of the even distribution of the combined signal from a plurality of samples from the ring oscillator 10 is sufficient to determine the degree of randomness for this signal. Statistical tests are successful if the zeros and ones are almost evenly distributed. For this, an arrangement is now proposed that forms a difference between the number of zeros and the number of ones and compares this difference against a prescribed maximum value. In this case, the ones and zeros can be counted in two separate counters and then a subtracting circuit can determine the difference, as shown in FIG. 4.

FIG. 3 shows the sampling unit 51 with the first flipflops 30, 32, 34, the first XOR element 102, the second XOR element 104 and the second flipflop 106. In addition, a clock divider 120, a 1-of-2 decoder 122, a separate counter or single counter for zeros 124, a single counter for ones 126 and a further flipflop 130 that receives a system clock 131 and outputs a storage and reset signal 133 are provided. The illustration shows the counting of the zeros and the ones of the compressed samples.

In this case, a subtractor can be designed as an adder such that it is supplied with one operand (the subtrahend) as a two's complement. In this case, the two's complement of the operand is formed such that all the bits of the subtrahend are inverted. This gives the one's complement and, if a one is added thereto, the two's complement. In this case, the one can also be added by virtue of permanently allocating one to the incoming carry in the adder, as shown with the signal 151 in FIG. 4.

FIG. 4 shows the difference formation for the counter readings by means of adder and two's complement and also the comparison. The illustration shows particularly the counter for zeros 124, the counter for ones 126, an inverter 150, an adder 152 and a comparator 154. Output 160 from the adder is a difference. This is input into the comparator 154 besides a fixed comparison value 162. The output 170 of the comparator indicates an error if the prescribed comparison value 162 is exceeded. A prescribed value is therefore used for comparison.

The result of this operation is the difference in ones and zeros. This difference can arise as a positive number if the first operand, the minuend, e.g. the number of ones, is greater than the second operand, which needs to be deducted, the subtrahend. In the opposite case, the result is negative and is present as a two's complement, in which the most significant bit (MSB, arithmetic sign bit) is equal to 1. In that case, all the result bits would need to be inverted and a 1 would need to be added in order to obtain the corresponding positive value. The positive difference value would then need to be compared with a firmly prescribed value. To this end, the BSI prescribes an admissible deviation in the specification AIS 31 P2.i)(vii). In this case, for 100 000 random bits, a deviation in the number of ones by fewer than 2500 from the expected value 50 000 is admitted. Allowing for the fact that with a relatively high number of ones the number of zeros simultaneously falls by the same amount (and vice versa), the difference described above cannot reach the value 5000 in the case of 100 000 random bits. The difference is therefore compared against this value (see FIG. 4).

In one refinement of the method, the difference formation can also be effected easily by virtue of just one counter being used that can count upward and downward. If a 1 prompts counting upward and a 0 prompts counting downward, the difference arises immediately after the conclusion of the check in the counter, as is evident from FIG. 5.

FIG. 5 shows the difference formation for the counter readings by means of an up/down counter. The illustration shows the sampling unit 51 with the three first flipflops 30, 32, 34, the XOR elements 102, 104, the clock divider 120 and the further flipflop 130. Output s012″ from the second flipflop 106 is input into an up/down counter 200, the output 202 of which carries a difference.

In a further refinement, the difference can be inverted on the basis of the uppermost result bit or arithmetic sign bit. As a result, a positive number is always obtained that, in the case of a negative difference, is lower by the value 1 than is actually the case. This can be explained by the fact that negative numbers are presented in the two's complement. The two's complement is formed by inverting all the bits and subsequently adding 1. In the proposal above, the addition of 1 is omitted and then needs to be taken into account for the check.

In the case of 2500 ones too many, the difference would be 5000 or, in hexadecimal presentation, 0x1388. In the case of 2500 ones too few, the difference would be 5000 or, in hexadecimal, 0xEC78 for a representation of 16 bits. If the uppermost bit is used to invert all the bits, the positive value obtained is 0x1387, i.e. one fewer than in the above case. Since the difference must always be an even number (one more 1 is simultaneously one fewer 0), it is sufficient if the positive difference formed above is always compared to determine whether it is <4999 (hexadecimal 0x1387). The fixed value in FIG. 4 can then be set to 4999. The check is performed after 100 000 random bits in each case. The counters are then reset to zero. If the difference is not less than 4999, an error signal is output. This error signal can be used so that the random bits produced are not used or the random generator disables its output until the test is successful again. In addition, both the frequency of the sampling clock and the compression factor n can be varied until the test is successful.

It should be noted that the requisite circuit complexity is very low and digital standard methods can be used.

A TRNG can be implemented using the method presented. On account of the extremely low circuit complexity (approximately 200 gate equivalents), it can be used practically wherever randomness plays a part. In future, such TRNGs can be used in sensor evaluations for manipulation prevention or in security applications for connections to the Internet.

In addition, a circuit arrangement is presented that comprises a random source having at least one output that delivers a sequence of random bits that is compressed by a factor n by means of serial linear logic combination, and as a result a compressed random bit is produced and the ones and zeros in the series of compressed random bits are counted. For a fixed number of random bits, the difference in the zeros and ones is formed and this difference is compared with a prescribed value.

In the random source, a plurality of signals can be logically combined with one another in linear fashion to form an output. In addition, the ones and zeros can be counted in separate counters.

The difference formation can be effected by an adder that is supplied with an operand bit by bit in inverted form (one's complement), and the incoming carry for the adder is set to 1.

In addition, provision may be made for an up/down counter to be used for counting and difference formation, in which the counter counts upward when the relevant compressed random bit is equal to 1 and counts downward when said random bit is equal to 0, so that following the conclusion of the checking operation the difference is present in the counter.

Furthermore, provision may be made for the difference to be presented as a two's complement, with the most significant bit (MSB) of this difference being the arithmetic sign bit and all the bits of the difference being inverted on the basis of the value of the MSB, so that the result is always a positive value.

In one embodiment, the positive value is compared against a fixed comparison value, with the choice of the comparison value taking account of the fact that in the event of a negative difference the inversion of all the bits forms a positive value that is less than the actual difference by the value 1, and the difference formation between zeros and ones is always twice as great as the deviation in the number of ones or zeros from the ideal mean value.

In addition, an error signal can be output in the event of an unsuccessful comparison.

In the event of an error signal, the checking operation can be reset, the check can be performed again for freshly generated random bits and a decision can be made as to whether the previously formed random bits are rejected.

The comparison of the difference with the comparison value can be taken as a basis for varying the compression factor n.

Provision may be made for the random source to comprise at least one ring oscillator that is sampled at least one position, and for the sampling frequency to be varied on the basis of the comparison of the difference with the comparison value.

The aforementioned embodiments based on a circuit arrangement having a random source are also conceivable in conjunction with an arrangement for checking an output from a random source of a random number generator.

What is claimed is:

1. A method for checking an output signal from a random source of a random number generator, comprising:
receiving the output signal, the output signal including first random bits with a bit length of at least one bit and the random source being sampled using a sampling unit to produce the output signal;
counting, using a processing unit, ones and zeros in the output signal from the sampling unit to form a first difference in the ones and zeros for a first fixed number of the first random bits; and
comparing the first difference with a predetermined value to check the output signal.

2. The method according to claim 1, further comprising:
providing compression, using the processing unit, wherein the compression includes:
performing block-by-block linear logic combination for a first number of successive bits of the output signal to produce a compressed output signal, the compressed output signal having a series of compressed signal values and the first number being a compression factor; and
counting the ones and zeros in the series of compressed signal values.

3. The method according to claim 1, wherein the counting of the ones and zeros further comprises:
counting the ones and zeros in separate counters.

4. The method according to claim 1, wherein the formation of the first difference is effected by an adder, the adder receives an operand bit by bit in an inverted form, and incoming carry for the adder is set to 1.

5. The method according to claim 1, wherein the counting the ones and zeros further comprises:
counting the ones and zeros using an up/down counter, the counter counting upward when a compressed random bit is equal to 1 and the counter counting downward when the random bit is equal to 0 to enable the first difference to be present in the counter after the checking of the output signal.

6. The method according to claim 1, wherein the first difference is represented as a two's complement, the first difference including second bits with a MSB, the MSB being an arithmetic sign bit and having a value, and the second bits being inverted based on the value of the MSB to enable the first difference to be a positive value.

7. The method according to claim 6, further comprising:
selecting the predetermined value:
(i) by inverting the second bits to form the positive value if the first difference has the negative value, the positive value being less than a negative value by 1, and
(ii) with reference to the first difference being twice as great as a deviation in ones and zeros from an ideal mean value; and
comparing the positive value against the predetermined value.

8. The method according to claim 1, further comprising:
to providing an error signal if the comparison of the first difference with the predetermined value is unsuccessful.

9. The method according to claim 8, further comprising:
receiving second random bits in response to an error signal;
counting the ones and zeros from the second random bits to form a second difference in the ones and zeros for a second fixed number of the second random bits;
comparing the second difference with the predetermined value to check the second random bits; and
determining whether to reject the second random bits based on the check.

10. The method according to claim 1, further comprising:
varying a compression factor based on the comparison of the first difference.

11. The method according to claim 1, wherein the random source comprises a ring oscillator, the ring oscillator being sampled at one or more positions based on a sampling frequency and the sampling frequency being varied based on the comparison of the first difference.

12. An arrangement for checking output signals from a random source of a random number generator, wherein the arrangement is configured to:
receive the output signals, the output signals having random bits with a bit length of at least one bit and the random source configured to be sampled using a sampling unit to produce the output signals;
count, using a processing unit, the ones and zeros in series of the received output signals;
form a difference in zeros and ones for a fixed number of the random bits; and
compare the difference with a prescribed value to check the output signals.

13. The arrangement according to claim 12, wherein the arrangement is further configured to:
provide compression, using the processing unit, the compression including:
performing block-by-block linear logic combination for a first number of successive bits of the output signals to produce a compressed output signal having a series of compressed signal values, the first number being a compression factor.
